(19) United States
(12) Patent Application Publication
(10) Pub. No.: US 2005/0288947 A1
(43) Pub. Date: Dec. 29, 2005

(54) Method and system for tracking assets in a transportation network

(76) Inventors: Cynthia F. Mallonee, Huntington, MD (US); George R. Kelly, Crofton, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/954,105

(22) Filed: Sep. 30, 2004

Related U.S. Application Data
(60) Provisional application No. 60/573,322, filed on May 24, 2004.

(51) Int. Cl. G06Q 99/00

(52) U.S. Cl. 705/1

(57) ABSTRACT

Systems and methods for tracking assets of a service provider in a transportation network may comprise assigning a destination and route to a transportation container having an associated permanent identification marker. A client may generate a unique identification label for the transportation container, wherein the unique identification label includes information regarding the destination and route assigned to the container. Thereafter, the unique identification label is attached to the transportation container. The client also receives first information pertaining to the unique identification label attached to the transportation container, and second information pertaining to the permanent identification marker associated with the transportation container. Handling units containing delivery items are loaded into the transportation container.

### RELATED APPLICATIONS

This application claims the benefit of U.S. Provisional Patent Application No. 60/573,322, entitled “Method and System for Surface Transportation Network,” which was filed on May 24, 2004, the disclosure of which is hereby expressly incorporated herein by reference.

### TECHNICAL FIELD

This invention relates generally to management of a distribution transportation network including real time tracing and tracking of transportation assets and related data.

### BACKGROUND

Today, transportation and distribution are a critical part of any country's economy. To provide quality transportation and distribution service, a transportation service provider must create and maintain a highly organized integrated network for tracking its assets, such as handling units, vehicles, etc. Effective management of such networks allows lower cost, reduced delivery time, and enhanced customer service. Management of an integrated transportation network may include management of asset tracking infrastructure and logic, management of distribution, and management of information services supporting tracking and tracing of items in transit. Another important component of an integrated transportation network is proactive management of the transportation supply chain from induction to destination.

To plan, maintain, monitor, and optimize an integrated transportation network, a service provider may need to collect real time data related to in-transit tracking of service provider assets and provide it to the network. Currently, most delivery item transport equipment used by service providers to transport handling units, such as letter trays, flat tubs, and parcel sacks, remain “invisible” to a transportation network while in transit between origin and destination points. A service provider may have no knowledge of the real time location of a specific handling unit or container once it is dispatched from the origin point. In addition, today, a service provider may have no knowledge of its real-time assets inventory enabling it to account for or locate each handling and transportation unit or trailers.

When a delivery item, such as a mailpiece, does not arrive at its destination within the expected time frame, a service provider may be unable to identify a reason for the delay. Unfortunately, errors in dispatching delivery items sometimes may be made. If a service provider makes a mistake by dispatching delivery items on the wrong transportation route, for example, by placing an item on a truck traveling in a direction different from an item destination point, an error may not be discovered until the item arrives at the truck's final destination. A delay in arrival of a delivery item may also be caused by a delay in processing at an origin processing plant, or by a delay in arrival of a transportation unit, such as a truck or a trailer, to its destination caused by circumstances outside of a service provider's control, for example, due to bad weather or slow traffic.

Continuous tracing and tracking of a service provider's assets may be significantly complicated when destination points and transportation routes do not remain the same, but instead change on a daily basis, even for delivery items inserted into a processing stream at the same origination point. For example, the same individuals and the same organizations may need to send items to different recipients located in the different geographical areas. When a service provider is forced to frequently change routes between destination and delivery points, an ability to continuously monitor and frequently re-evaluate delivery routes and methods may be needed. Effective management of routes and dock operations at plants may also allow a service provider to identify and prevent potential operational “bottlenecks” and scheduling conflicts within the transportation network. Close real time monitoring of transportation network may also allow a service provider to continuously evaluate performance of its transportation carriers and improve their management resulting in lowering the transportation cost. To continuously identify cost reduction opportunities, a service provider may also need to monitor data related to capacity utilized by every transportation unit. For example, identifying trucks loaded less than their full capacity, may enable a service provider to increase utilization of its transportation network. Increased capacity utilization of trailers may result in reduced amount of transportation needed to transport the same volume of mail ultimately reducing the cost of transportation to a service provider.

It is therefore desirable to provide a centralized transportation network visibility system capable of providing unique identification of delivery item transport containers and trailers; providing visibility as delivery item handling units, containers, and trailers move within the transportation network; maximizing utilization of transportation trailers; facilitating continuous real time collecting of transportation related data; monitoring processing and transportation of a service provider's transportation assets; providing a service provider with raw data and analytical tools to measure and improve transportation network performance, including improvement and continuous re-evaluation of business rules for dispatching and routing, enabling enhanced planning ability from a service provider and a reduced amount of misrouted handling units and containers; and enabling a service provider to continuously maintain, plan, and manage a distribution and transportation network at the strategic, tactical, and operational levels.

### SUMMARY

Consistent with embodiments of the present invention, systems and methods are disclosed for tracking assets of a service provider in a transportation network. Systems and methods for tracking assets may comprise assigning a destination and route to a transportation container having an associated permanent identification marker. A client may generate a unique identification label for the transportation container, wherein the unique identification label includes information regarding the destination and route assigned to the container. Thereafter, the unique identification label is attached to the transportation container. The client also receives first information pertaining to the unique identification label attached to the transportation container, and second information pertaining to the permanent identification marker associated with the transportation container. Handling units containing delivery items are loaded into the transportation container.

### BRIEF DESCRIPTION OF THE DRAWINGS

The accompanying drawings, which are incorporated in and constitute a part of this disclosure, illustrate various embodiments and aspects consistent with the present invention. In the drawings:

FIG. 1 is an exemplary block diagram depicting exemplary transportation routes of a handling unit via different modes of transportation;

FIG. 2 is an exemplary 24-digit distribution label consistent with the principles of the invention;

FIG. 3 is an exemplary transportation container placard consistent with the principles of the invention;

FIG. 4 is an exemplary flowchart for scanning handling units and transportation containers identification labels during loading of handling units into transportation containers consistent with the principles of the invention;

FIG. 5 is an exemplary flowchart for linking transportation containers with destination identification of handling units in a transportation network database consistent with the principles of the invention;

FIG. 6 is an exemplary diagram depicting scanning events of transportation container identification labels during transportation consistent with the principles of the invention;

FIG. 7 is an exemplary diagram depicting scanning events during transportation containers delivery by highway vehicles consistent with the principles of the invention;

FIG. 8 is an exemplary diagram depicting scanning events during transportation containers delivery by freight rail consistent with the principles of the invention;

FIG. 9 is an exemplary diagram depicting scanning events during transportation containers delivery by Amtrak consistent with the principles of the invention; and

FIG. 10 is an exemplary network environment in which features and aspects consistent with the principles of the invention may be implemented.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Moreover, although the following description describes examples relating to mailpieces, it is to be understood that such description is equally applicable to other types of delivery items. Accordingly, the following detailed description does not limit the invention. Instead, the proper scope of the invention is defined by the appended claims.

To accumulate numerous mailpieces for simultaneous handling, storage, loading, transporting, and unloading, a service provider, such as the United States Postal Services (USPS), may use mail handling units, for example, letter trays, flat tubs, and parcel sacks.

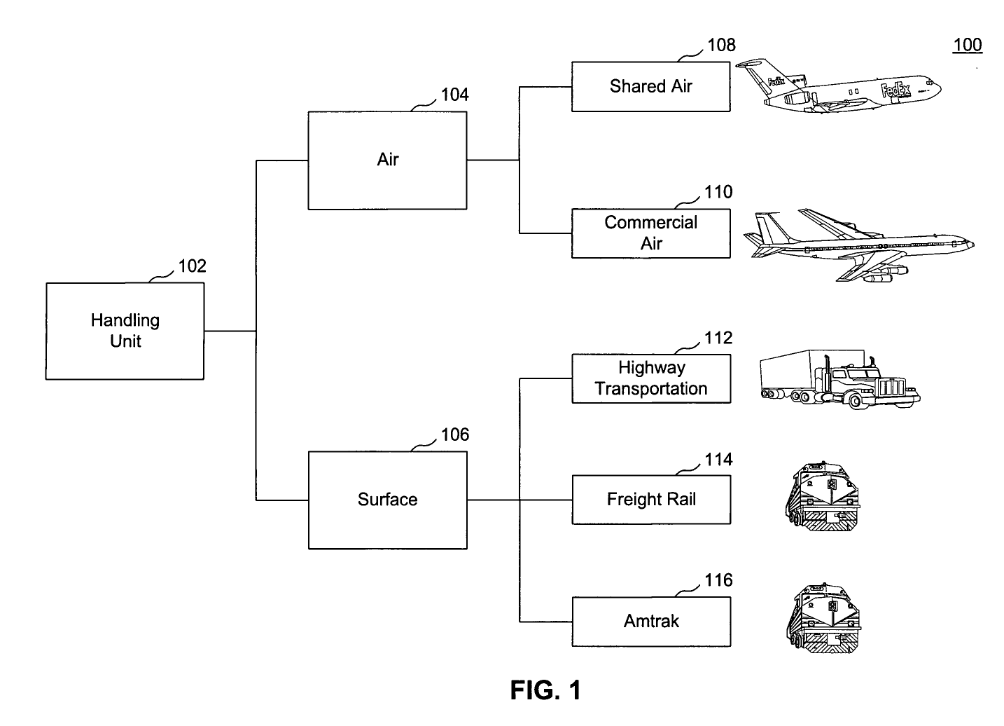

FIG. 1 is an exemplary block diagram 100 depicting exemplary transportation routes that a handling unit 102 may travel via different modes of transportation. A handling unit 102 may be, for example, a letter tray, flat tub, parcel sack, etc. A service provider may use either an air carrier 104 or surface carrier 106 to deliver a handling unit to its destination. If an air carrier is chosen, a service provider may use a shared air carrier 108 or a commercial air provider 110. If a surface delivery is preferred, a service provider may have a choice between highway transportation 112, freight rail 114, and Amtrac 116.

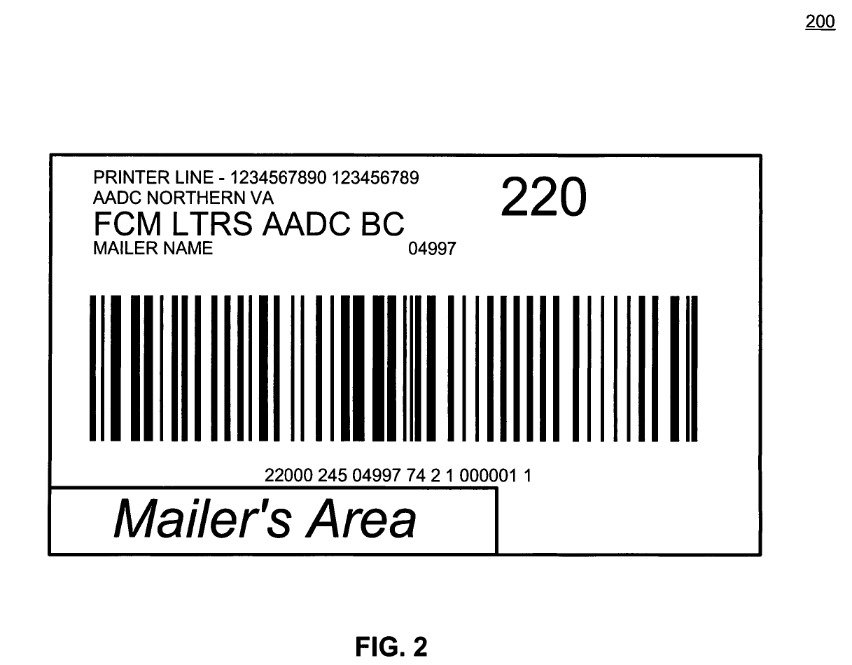

To uniquely identify each handling unit for subsequent tracking, regardless of a transportation carrier, a service provider may assign each handling unit a unique identification number. To facilitate tracking of handling units, a service provider may attach to each handling unit a distribution label depicting the unique identification number in the form of a barcode. FIG. 2 shows an exemplary 24-digit distribution label 200 that a service provider may use to uniquely identify a handling unit. One of ordinary skill in the art will appreciate that other forms of unique identification may alternatively be utilized.

At an origination point, every time a new combination of mailpieces is loaded into a handling unit for subsequent handling, a new unique distribution label 200 may be created and attached to a handling unit. Unique information contained in a barcode depicted on a distribution label, may include origin and destination points, a date when the mailing was originated, a date when a handling unit is expected to arrive to its destination point, and/or any other handling unit transportation and content related information. In one embodiment, unique information in a barcode depicted on a distribution label may include a range of unique delivery addresses, such as ZIP™ codes, for mailpieces loaded into a handling unit. When a handling unit reaches its destination and individual mailpieces are removed for individual delivery, a unique distribution label may be removed from a handling unit and destroyed.

To identify and track each handling unit as it travels along its delivery route, a service provider may scan a unique barcode depicted on a distribution label. As discussed below, within a mail distribution center, a service provider may use conveyor scanners to scan a unique distribution label affixed to a handling unit. This passive type of scanning may require no human interaction. In an alternative embodiment, a unique distribution label of a handling unit may be scanned by a manual barcode scanner operated by an employee of a service provider. A more detailed description of scanners is provided in Exhibits B, I, and J, of U.S. Provisional Patent Application No. 60/573,322, which is incorporated herein by reference.

Typically, to accumulate and handle numerous handling units for subsequent transportation, a service provider may use transportation containers. Generally, a container may refer to mail transport equipment used to move mail in-plant or between postal facilities. Exemplary containers may include rolling containers, pallets, general purpose mail containers, eastern region mail containers (ERMC), wire containers, bulk mail center over-the-road (BMC-OTR) containers, BMC in-house containers, etc. A service provider may use trailers, trucks, and/or other vehicles capable of carrying one or more containers in order to transport containers between processing facilities.

A service provider may assign to each container and trailer a unique identification number, thus enabling tracking of individual transportation containers and trailers along transportation routes. For example, the service provider may associate a container or trailer with a unique number known as a permanent identification number, which may be depicted as a barcode. A permanent identification number may identify a container or a trailer, for example, using a unique serial number and the container or trailer type.

A service provider may create and attach a permanent identification number, such as a license plate, that includes a number, such as a license plate number, to each container and trailer. Once a license plate is affixed to a container or a trailer, it may remain affixed for a lifetime of a container or a trailer. A unique license plate number may be depicted on a license plate in multiple formats enabling the tracking of a container or a trailer in different environments. For example, a license plate may include a barcode, a radio frequency identification (RFID) tag, and/or a human readable label. Having different types of identifications depicted simultaneously may enable a service provider to scan a license plate along the transportation route using different identification technologies without major alteration of existing processing operations.

To facilitate tracking of a container or a trailer, a service provider may create a unique identification label, such as a placard, depicting, for example, a range of delivery areas of a container's contents, along with the container's destination and routing information. In one embodiment, this unique identification label may depict a range of delivery areas for a container's contents in the form of ZIP™ codes, along with the container's destination and routing information.

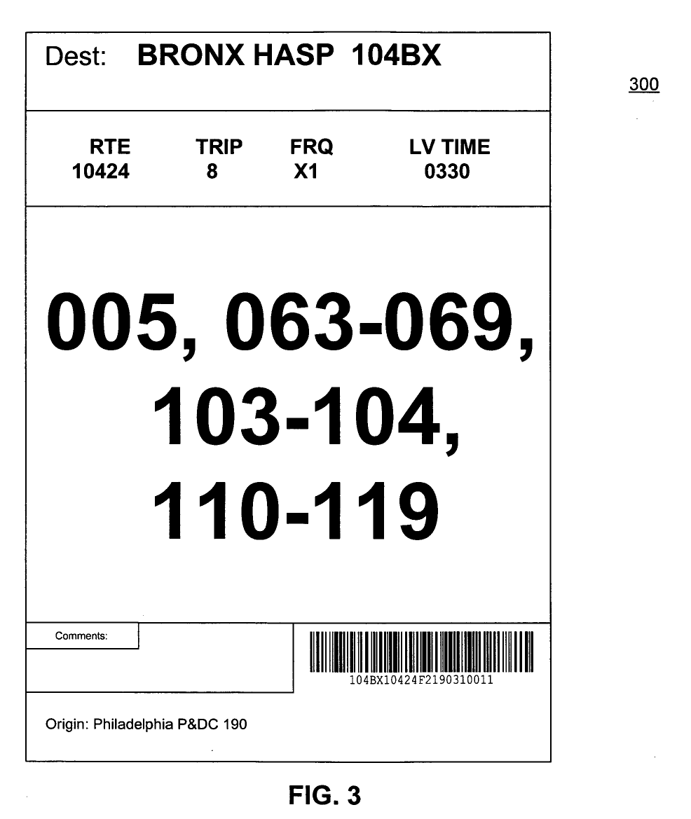

FIG. 3 depicts an exemplary container placard 300, which, as noted above, is a unique label identifying a container's unique information depicted as a barcode. Container placard 300 may also include human-readable destination information. After destination and routing data for a container is determined, a placard for a container may be generated and an employee of a service provider may affix it to a transportation container. Alternatively, the placard may be automatically affixed to a transportation container without human intervention.

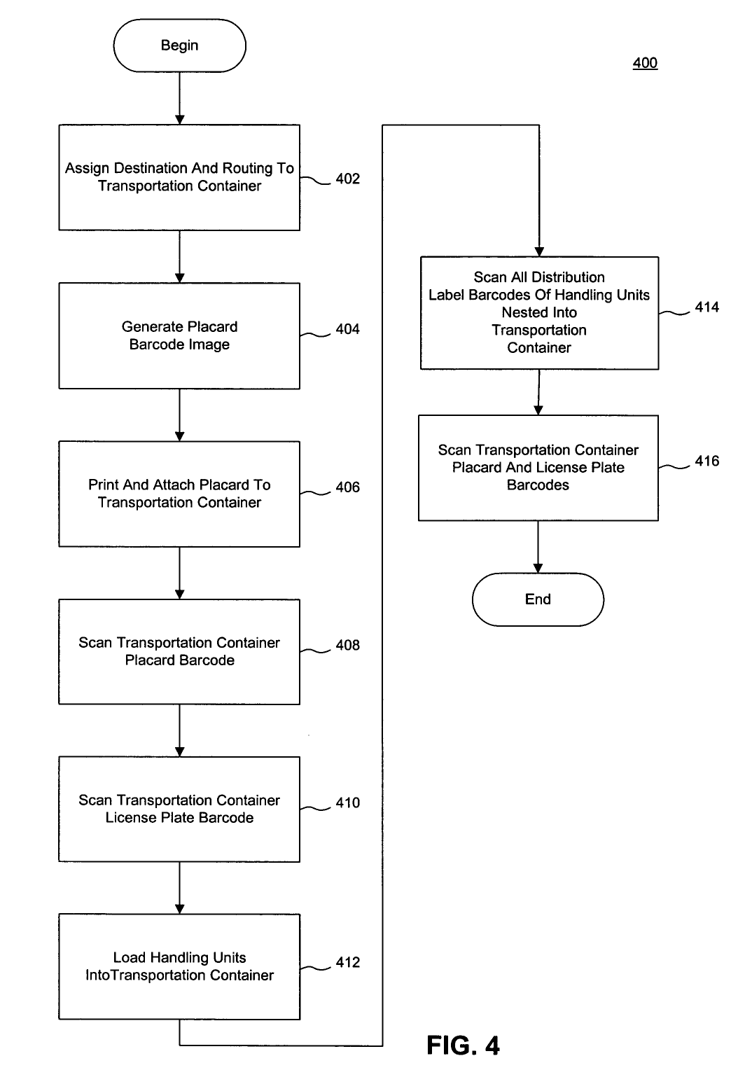

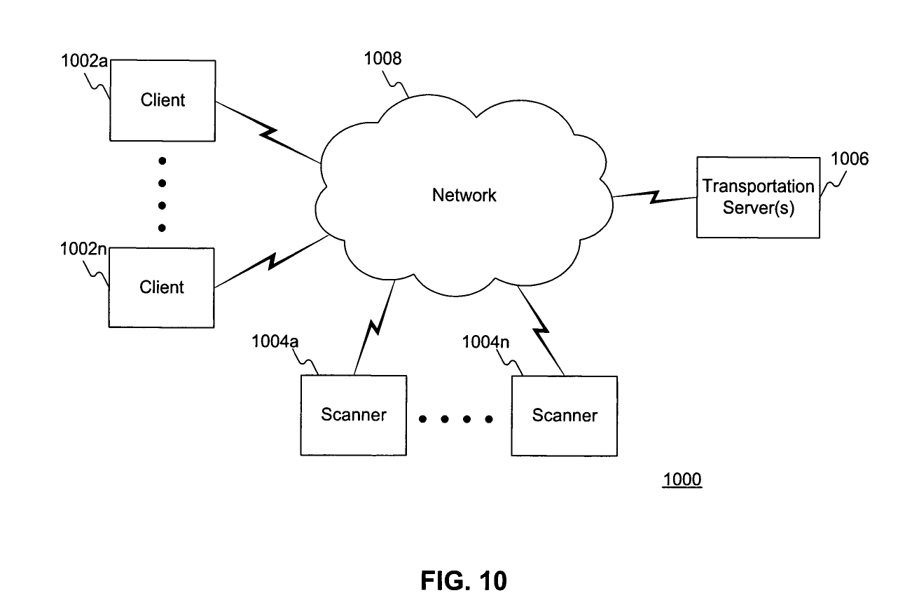

FIG. 4 is an exemplary flowchart 400 for scanning identification labels of handling units and transportation containers, such as placards and license plates, during loading of handling units into transportation containers. After a transportation container arrives to a loading area, such as a bullpen, an employee of a service provider may assign a destination delivery point and a corresponding transportation route to a transportation container (step 402). One of ordinary skill in the art will appreciate that this assigning may alternatively occur automatically, without human intervention. Having destination and routing data for a transportation container may enable the service provider to generate a placard that includes a barcode for that transportation container (step 404). For example, a suitable computer program resident on a client 1002 (see FIG. 10) may be utilized to create a placard that reflects a range of delivery areas of a container's contents, along with the container's destination and routing information. Once a placard is generated, the service provider may cause the placard to be printed and then affixed to a corresponding transportation container (step 406). For example, client 1002 may initiate printing of the placard. Once the placard has been printed, an employee of the service provider or other user of client 1002 may place the placard on the proper transportation container. Alternatively, the placard may be fixed to its corresponding transportation container automatically.

After a transportation container is assigned a transportation route and destination, the service provider may scan the placard barcode (step 408) and license plate barcode (step 410) associated with a transportation container. For example, a client 1002 or a scanner 1004 (see FIG. 10) may be utilized to implement the scanning. In one embodiment, in order to prevent inadvertent human errors, once for example, a placard has been scanned, a scanner may not accept any other scanning except for the scanning of a corresponding license plate. Following scanning of barcodes from several transportation containers, scanned data may be automatically or manually forwarded to a transportation server (see e.g., transportation server 1006 in FIG. 10) by uploading scans from the scanner memory to a database associated with the transportation server. Further details of this scanning and uploading may be found in Exhibit I of U.S. Provisional Patent Application No. 60/573,322, which is incorporated herein by reference. After the transportation server receives unique data depicted on a placard and a license plate, the server may assign a route and a destination point for that transportation container, if not already assigned.

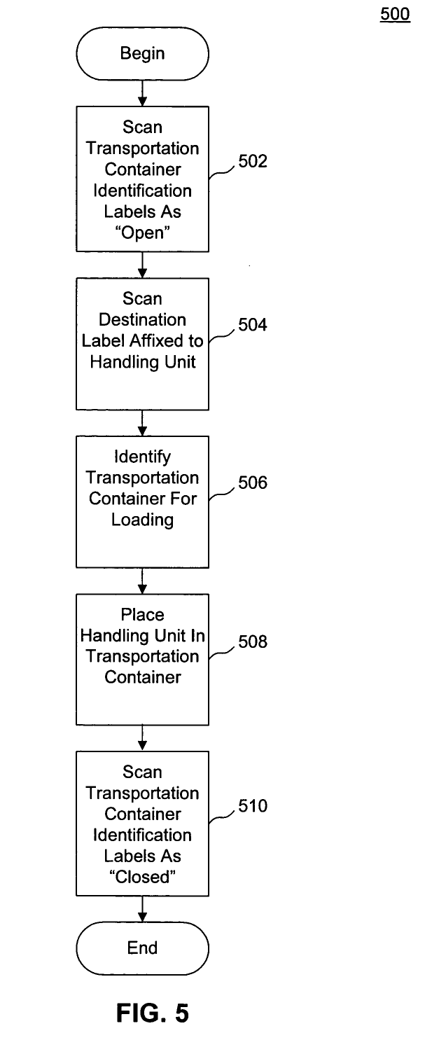

After barcodes of a transportation container license plate and placard have been scanned, loading of handling units into a transportation container may begin (step 412). To determine appropriate placement of handling units into transportation containers, distribution labels of handling units may be scanned as described below with reference to FIG. 5. Handling unit distribution labels depicting unique barcode identification may be scanned (step 414) as handling units are loaded into a transportation container as described below. To complete the loading process, the transportation container license plate and placard barcodes may be scanned again (step 416).

FIG. 5 is an exemplary flowchart 500 for continuous linking of transportation containers with handling units in a transportation database. In a transportation database, a transportation container may be identified as “open” when its identification labels are scanned (step 502) prior to the beginning of the loading with handling units. Before a transportation container receives any handling units, their distribution labels may be scanned (step 504), for example, by a passive scanning device installed at the entrance of a bullpen. Alternatively, a manual scanner may be utilized. Scanning of distribution labels of handling units at the entrance of a bullpen may facilitate identification of transportation container for loading (step 506), enabling correct placement of handling units into the appropriate transportation containers and reducing the amount of misplaced and misrouted handling units. Once the transportation container is identified, it may be loaded (step 508). After a transportation container is fully loaded, its identification labels may be scanned again (step 510) and a transportation database may identify such container as “closed.” In one embodiment, following a scan identifying a transportation container as closed, no more handling units may be linked in a transportation database to that transportation container.

In yet another example, linking of handling units with transportation containers in a transportation database may be facilitated using, for example, a chronological sequence in which handling units enter a bullpen. A determination may be made based on a scan of a distribution label barcode of a last unit loaded into a transportation container. The last scan may indicate a range of handling units nested into a transportation container. All handling units entering the bullpen before the last handling unit for the current container, and after the last handling unit in the previous container are assigned to the current container. Further details on linking handling units with containers may be found, for example, in Exhibit A of U.S. Provisional Patent Application No. 60/573,322, which is incorporated herein by reference.

To ensure correct placement or nesting of each handling unit into transportation containers, a service provider may use a passive scanner as described in further detail in Exhibit E of U.S. Provisional Patent Application No. 60/573,322, which is incorporated herein by reference. A passive scanner installed above a conveyor feeding handling units into a bullpen may scan each handling unit distribution label as handling units enter the bullpen. In an alternative embodiment, to determine handling units' placement into transportation containers, an employee may scan handling units distribution labels using a manual scanner.

After a transportation container is loaded and its identification labels are scanned, a service provider may create a unique electronic compilation of data, such as an electronic manifest, related to the transportation container and its contents. An electronic manifest may contain an inventory of all the items loaded into transportation container including inventory of handling units and transportation container destination and routing information.

In one embodiment, an electronic manifest may include, for example, an expected arrival time to a destination point and the time when a transportation container was loaded. A service provider may store all electronic manifests in a separate database for an indefinite period of time. Stored electronic manifests may be used for tracking transportation containers and handling units and/or creating internal reports. Electronic manifests may be created by a client 1002 (See FIG. 10) and periodically be sent to a database resident at transportation server 1006. Alternatively, transportation server 1006 may generate electronic manifests based on information from clients 1002 and/or scanners 1004.

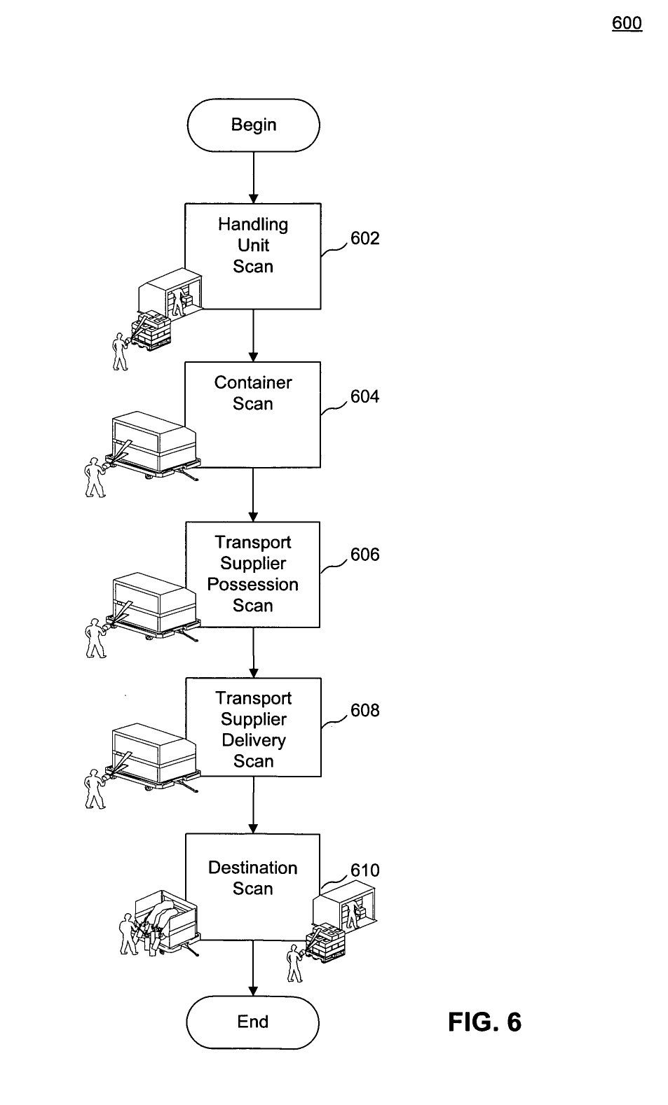

During transportation of a container via its transportation route, several scans of its identification labels may be performed to maintain continuous monitoring of transportation container status. FIG. 6 is an exemplary flowchart 600 depicting exemplary scanning events of transportation container identification labels during transportation. When a transportation container arrives at a transport supplier facility for transportation, a transport supplier may scan handling unit distribution label barcodes of each handling unit to be placed in the container (step 602). A transport supplier may then scan identification label barcodes of a transportation container (step 604). Having an ability to scan and electronically store identification data for handling units and transportation containers may enable a transport supplier to better facilitate transportation and tracking of handling units and transportation containers.

At an origination point, prior to loading transportation containers into a transport, for example, an airplane, a transport supplier may conduct a possession scan (step 606). This possession scan creates a link in a transportation database for a transportation container to a specific airplane. At the time of an airplane arriving to a destination point, a transport supplier may conduct a delivery scan (step 608). Following a transportation container arrival to a service provider facility at a destination point, a destination scan may be performed (step 610) to confirm safe arrival of handling units and transportation containers.

To facilitate tracking and tracing of trucks and trailers, a service provider may equip trailers and trucks with a unique label, for example, a license plate, depicting unique characteristics of a truck or trailer in the form of a barcode. For example, a trailer license plate may depict, in the form of a barcode, a trailer size, trailer number, transportation carrier identification number, and other unique trailer information. When a trailer or a truck arrives at a dock for loading, an employee may scan a trailer's unique license plate barcode and assign a destination point for a trailer using a dock management tool, which may be a mobile device wirelessly connected to a transportation network. A dock management tool is described in U.S. Provisional Patent Application No. 60/543,919 filed on Feb. 13, 2004, the entire contents of which are incorporated by reference herein.

Once a destination is selected, a dock management tool in response may provide a dock employee with a list of alternative routes generated by a network database. A dock employee then may assign a trailer or a truck to a destination point and a route. In an alternative embodiment, an employee may select one of the routes provided by a dock management tool or create a new route. Further details on a dock management tool and its functions are provided in Exhibits A, H, and J of U.S. Provisional Patent Application No. 60/573,322, which is incorporated herein by reference. One of ordinary skill in the art will appreciate that a client 1002 (FIG. 10) may be used to implement a dock management tool.

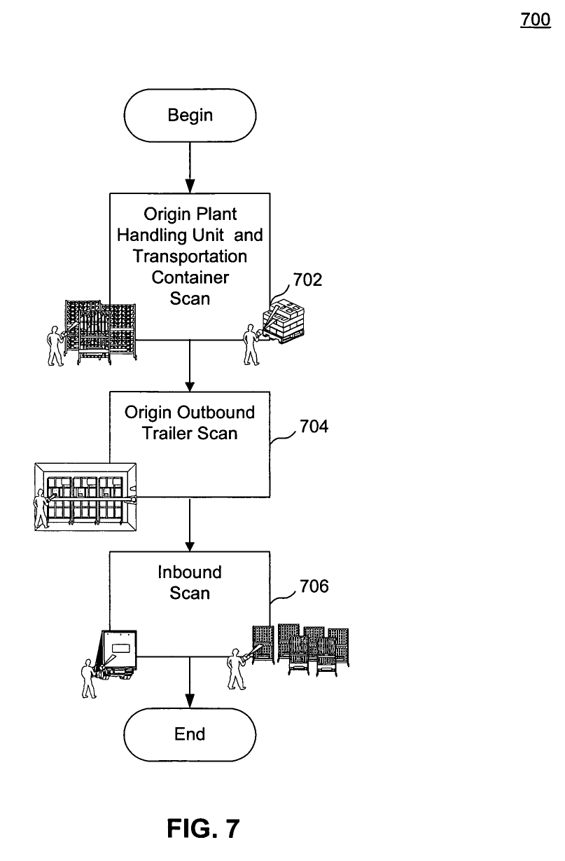

FIG. 7 is an exemplary flowchart 700 depicting exemplary scanning events for a surface transportation containers delivery by highway vehicles, for example, semi-trucks. A service provider may scan handling unit distribution labels and transportation container identification labels (step 702) as handling units and transportation containers are prepared at an origin plant of a service provider. A service provider may perform origin outbound trailer scan (step 704) after trailers are loaded and ready to leave a service provider facility. At that time, a service provider may scan the identification labels of transportation containers. When a trailer arrives at a destination facility, an inbound scan (step 706) may be performed.

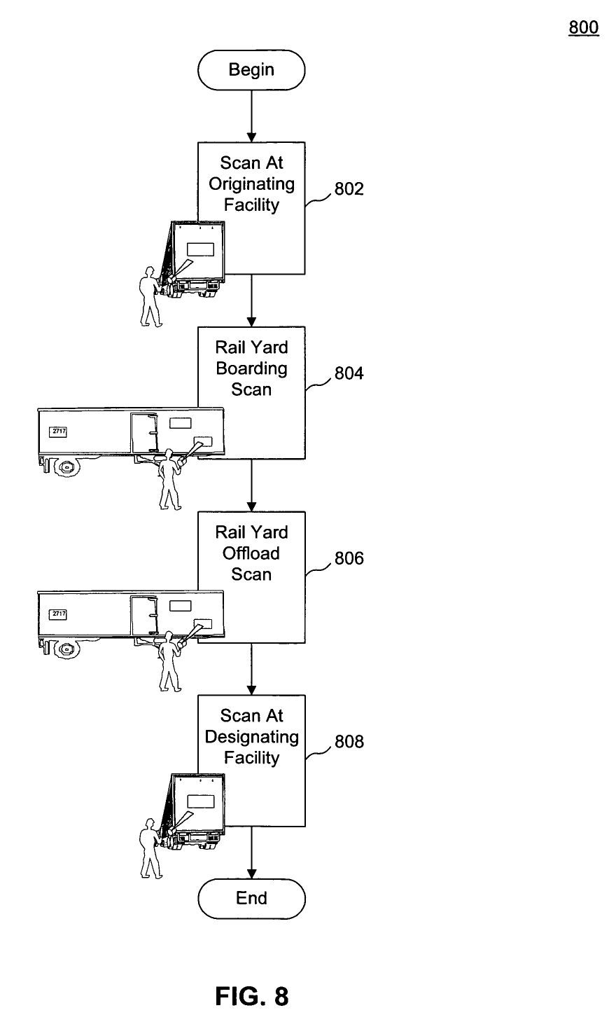

FIG. 8 is an exemplary flowchart 800 depicting exemplary scanning events during transportation of containers by freight rail. After a trailer arrives at an originating facility of a transport carrier, its transportation container identification labels may be scanned (step 802). Following trailer arrival at a rail yard of a transport carrier for loading onto a train, a rail yard boarding scan may be performed (step 804). Once a train arrives to a destination point, a transport carrier may conduct a rail yard offload scan (step 806). Another scan (step 808) may be performed by a service provider after a trailer arrives to a destination facility for processing purposes.

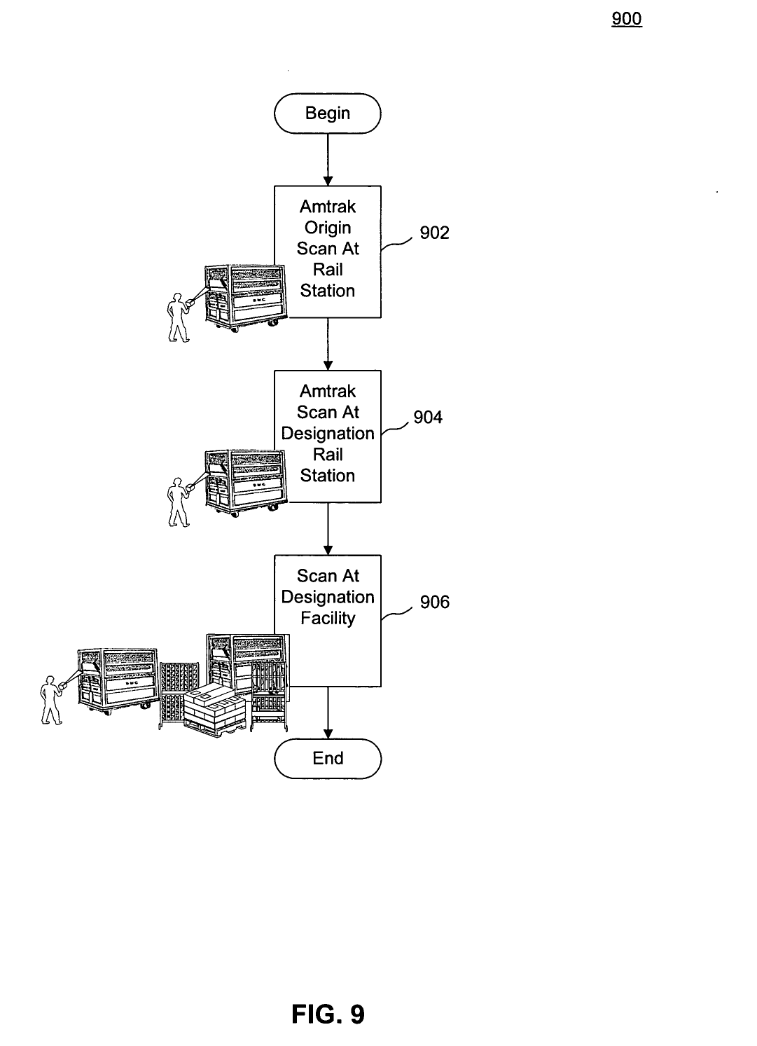

FIG. 9 is an exemplary block diagram 900 depicting exemplary scanning events during transportation of containers by Amtrak. After transportation containers arrive at an Amtrak origin rail station, identification labels of the transportation containers may be scanned (step 902). Then, transportation container identification labels may be scanned again at an Amtrak destination rail station (step 904). A service provider may scan transportation container identification labels again at a destination service provider facility for processing purposes (step 906).

FIG. 10 is an exemplary network environment 1000, in which features and aspects consistent with the principles of the invention may be implemented. The number of components in environment 1000 is not limited to what is shown and other variations in the number of arrangements of components are possible, consistent with embodiments of the invention. The components of FIG. 10 may be implemented through hardware, software, and/or firmware. Network environment 1000 may include clients 1002a-1002n, scanners 1004a-1004n, a transportation server 1006, and a network 1008.

Network 1008 provides communications between the various entities depicted in network environment 1000, such as a client 1002 or scanner 1004, and transportation server 1006. Network 1008 may be a shared, public, or private network and may encompass a wide area or local area. Network 1008 may be implemented through any suitable combination of wired and/or wireless communication networks. By way of example, network 1008 may be implemented through a wide area network (WAN), local area network (LAN), an intranet and/or the Internet. “Wireless” can be defined as radio transmission via electromagnetic waves. However, it may be appreciated that various other communication techniques can be used to provide wireless transmission, including infrared line of sight, cellular, microwave, satellite, packet radio, and spread spectrum radio.

Clients 1002a-1002n provide users with an interface to network 1008. Clients 1002a-1002n may be implemented using any computer capable of accessing network 1008, such as a general purpose computer or personal computer equipped with a modem. In one embodiment, clients 1002a-1002n may comprise a mobile terminal, such as a personal digital assistant (PDA), portable computer, or a hand held computer.

A client 1002 may be used by a user to facilitate the various scanning operations of FIGS. 4-9. For example, a client 1002 may include or otherwise be communicatively connected to a scanning device for use in scanning placards, license plates, and/or any other identification labels described above with reference to FIGS. 2-9. One of ordinary skill in the art will appreciate that instead of scanning information, a client 1002 may receive input reflecting the relevant identification information (e.g., identification information associated with a placard, license plate, or other identification label) from a user on a user interface, such as a keyboard, of client 1002. A client 1002 may also be operable to perform other operations noted above with reference to FIGS. 4-9. For example, a client 1002 may generate placard barcode images and subsequently print a corresponding placard.

Moreover, a client 1002 may be operable to create an electronic manifest. As described above, an electronic manifest may comprise an inventory of all items loaded into a transportation container, including an inventory of handling units and transportation container destination and routing information. Client 1002 may use stored electronic manifests to thereby track transportation containers and handling units, in addition to generating reports reflecting the status of different transportation containers and handling units. Client 1002 may generate a manifest using data stored locally at a memory resident at client 1002. Alternatively, client 1002 may receive data from a remote source, such as another client 1002, a scanner 1004, or a transportation server 1006, and subsequently use that data to generate an electronic manifest. In one embodiment, instead of generating an electronic manifest itself, the client 1002 may send a request for an electronic manifest to another client 1002 or to a transportation server 1006, which may proceed to generate an electronic manifest and send the manifest to the requesting client 1002.

Scan data and/or information pertaining to electronic manifests may be periodically uploaded from a client 1002 to transportation server 1006. When scan data is uploaded, the scan data may then be deleted from a memory of client 1002 in order to make room for additional scan data. Alternatively, client 1002 may retain a copy of the scan data after uploading.

Scanners 1004 may be scanning devices for use by employees of a service provider or other users to perform the various scanning operations of FIGS. 4-9. For example, instead of using a client 1002 to perform a scanning operation, a user may utilize a scanner 1004. Similar to clients 1002, scanners 1004 may periodically upload scan data to transportation server 1006. When scan data is uploaded, the scan data may then be deleted from a memory of scanner 1004 in order to make room for additional scan data.

One or more transportation servers 1006 present in network environment 1000 may be operable to facilitate tracking and tracing of service provider assets. For example, a transportation server 1006 may enable continuous tracking of the status and location of service provider assets. More particularly, using data periodically received from clients 1002 and/or scanners 1004, a transportation server 1006 may determine exactly where a service provider asset is and assess whether that asset is in a proper location.

For example, in the context of a trailer that is being used to transport multiple transportation containers, because the license plate that is used to track transportation containers and trailers is static across each route, the concept of an “operational life” may be employed to maintain uniqueness across routes. A container is considered assigned to a destination when a user scans the container license plate in conjunction with the placard barcode. The transportation container is considered to be “alive” on the route until it arrives at its destination.

The operational life of a trailer is defined as a specific route and trip. As noted above, the trailer may be assigned to a route and destination point prior to being loaded with containers. The route and destination point assignment creates a new operational life for the trailer. The trailer is considered to be alive on that route until it reaches the destination.

A user of a client 1002, for example, may send a request to a transportation server 1006 for information on trailers currently present or en-route to a dock associated with the client 1002. For trailers that are en-route, transportation server 1006 may check to see whether the trailer left its origin late, which may be an indication that the trailer may be arriving at the destination late. The transportation server 1006 may also provide the client 1002 with information that indicates which transportation containers are loaded onto a particular trailer, as well as information indicating which handling units are in the transportation containers, along with the number and type of handling units.

This en-route information may help a user predict incoming mail flows. For example, normal mail flow may have trailers A, B, and C arriving 15 minutes apart. But on a specific evening, trailers A and B depart from their respective origins late resulting in all three trips arriving at the same time. The user in this case may proactively identify this schedule anomaly using the en-route information (e.g., inbound status information) and adjust staffing to account for it.

For outbound operations, a transportation server 1006 may provide a client 1002 with information representing the status of the dispatch operation on each transportation route. For example, for each route, information may be provided indicating that a trailer is available for loading with containers. Information associated with each trailer may also be provided indicating, for example, which containers have already been loaded onto the trailer, which containers have been staged for loading onto the trailer, and which containers are in the bullpen being loaded with handling units.

This outbound status information helps a user identify containers that should be loaded onto a trailer before departure. This gives the user information necessary to improve transportation utilization by ensuring that all available containers are used to fill available trailer space. It also improves service commitments by getting the containers onto the earliest available trailer.

Transportation server 1006 may also be used to help reduce the volume of misrouted handling units and transportation containers. For example, each time a scan of a handling unit is performed, the client 1002 or scanner 1004 may send transportation server 1006 information reflecting an identification of the container into which the handling unit is being loaded. The transportation server 1006 may then look up the destination of the container information and send this destination back to the client 1002 or scanner 1004, where a comparison is made between the destination of the container and the destination of the handling unit (which may be extracted from the content of the handling unit's barcode) to ensure that they match. Alternatively, the comparison may occur at the transportation server 1006, with the result of the comparison being sent back to the client 1002 or scanner 1004. With respect to transportation containers, similar destination comparisons may be made using the license plates associated with containers and trailers.

A transportation server 1006 may also employ the concept of an “asset purgatory.” More particularly, the operational life concept is used to track the same asset as they are reused on different routes. An asset is “born” on a new operational life when it is assigned to a new route, and the life is terminated when the asset reaches its destination. The assignment of a route to an asset is necessary to ascertain what route the asset is currently being used on. This route awareness supports validation during nesting operations, real-time feedback displays, as well other concepts discussed above.

Because an asset assignment is needed to maintain the operational life for that asset, and this assignment may be dependent on a human task (e.g., a scan or entry on a client), transportation server 1006 may use business rules and logic defined by a service provider to compensate for late or missing assignments. This is done through the asset purgatory concept. Essentially, the asset purgatory concept involves storing information pertaining to unassigned assets. Any events that occur on an unassigned asset are routed to the “asset purgatory.” If the asset is later assigned to a route, its records in this asset purgatory are removed. In this manner, when an asset, such as a transportation container or trailer is scanned, if a record corresponding to the container or trailer is found in the asset purgatory, a user may be informed that the container or trailer needs to be assigned a route, destination, or whatever information may be missing.

While certain features and embodiments of the invention have been described, other embodiments of the invention will be apparent to those skilled in the art from consideration of the specification and practice of the embodiments of the invention disclosed herein. For example, a service provider may use RFID technology or laser readable barcodes for distribution labels, placards, and other identification tags. In yet another example, scanned data depicted on placards, distribution labels, and license plates may be forwarded to a transportation server immediately upon scanning via wireless communications. Other alternatives are possible without departing from the spirit and scope of the invention.

Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for tracking assets of a service provider in a transportation network, comprising:
assigning a destination and route to a transportation container having an associated permanent identification marker;
generating a unique identification label for the transportation container, wherein the unique identification label includes information regarding the destination and route assigned to the container;
attaching the unique identification label to the transportation container;
receiving first information pertaining to the unique identification label attached to the transportation container; and
receiving second information pertaining to the permanent identification marker associated with the transportation container,
wherein handling units containing delivery items are loaded into the transportation container.

2. The method of claim 1, wherein the delivery items comprise mailpieces.

3. The method of claim 1, wherein the unique identification label is a placard.

4. The method of claim 1, wherein the unique identification label comprises a barcode.

5. The method of claim 1, wherein the unique identification label includes information indicative of a range of delivery areas for contents of the transportation container.

6. The method of claim 1, wherein the unique identification label includes human-readable destination information.

7. The method of claim 1, wherein the permanent identification marker comprises a license plate.

8. The method of claim 1, further comprising:
storing the first information and the second information.

9. The method of claim 1, further comprising:
sending the first information and the second information to a server.

10. The method of claim 1, wherein receiving information pertaining to the unique identification label comprises:
scanning the unique identification label attached to the transportation container to produce first scan data.

11. The method of claim 1, wherein receiving second information comprises:
scanning a license plate associated with the transportation container to produce second scan data.

12. The method of claim 1, further comprising:
receiving information pertaining to distribution labels associated with the handling units, wherein the distribution labels uniquely identify the handling units.

13. The method of claim 12, wherein the distribution labels comprise 24-digit distribution labels.

14. The method of claim 12, wherein the distribution labels comprise barcodes.

15. The method of claim 12, wherein the distribution labels include at least one of origin information, destination information, origin date information, and expected delivery date information.

16. The method of claim 1, wherein the permanent identification marker comprises a barcode, a radio frequency identification tag, and a human readable label.

17. The method of claim 1, further comprising:
linking the handling units with the transportation container.

18. The method of claim 1, further comprising:
creating an electronic manifest corresponding to the transportation unit.

19. The method of claim 18, wherein the electronic manifest comprises an inventory of items loaded into the transportation container.

20. The method of claim 1, further comprising:
receiving information pertaining to a license plate associated with a transportation vehicle in which the transportation container is loaded.

21. The method of claim 20, further comprising:
linking the transportation vehicle with the transportation container.

22. An apparatus for tracking assets of a service provider in a transportation network, comprising:
means for assigning a destination and route to a transportation container having an associated permanent identification marker;
means for generating a unique identification label for the transportation container, wherein the unique identification label includes information regarding the destination and route assigned to the container;
means for attaching the unique identification label to the transportation container;
means for receiving first information pertaining to the unique identification label attached to the transportation container; and
means for receiving second information pertaining to the permanent identification marker associated with the transportation container,
wherein handling units containing delivery items are loaded into the transportation container.

23. The apparatus of claim 22, wherein the delivery items comprise mail pieces.

24. The apparatus of claim 22, wherein the unique identification label is a placard.

25. The apparatus of claim 22, wherein the unique identification label comprises a barcode.

26. The apparatus of claim 22, wherein the unique identification label includes information indicative of a range of delivery areas for contents of the transportation container.

27. The apparatus of claim 22, wherein the unique identification label includes human-readable destination information.

28. The apparatus of claim 22, wherein the permanent identification marker comprises a license plate.

29. The apparatus of claim 22, further comprising:
means for storing the first information and the second information.

30. The apparatus of claim 22, further comprising:
means for sending the first information and the second information to a server.

31. The apparatus of claim 22, wherein the means for receiving information pertaining to the unique identification label comprises:
means for scanning the unique identification label attached to the transportation container to produce first scan data.

32. The apparatus of claim 22, wherein the means for receiving second information comprises:
means for scanning a license plate associated with the transportation container to produce second scan data.

33. The apparatus of claim 22, further comprising:
means for receiving information pertaining to distribution labels associated with the handling units, wherein the distribution labels uniquely identify the handling units.

34. The apparatus of claim 33, wherein the distribution labels comprise 24-digit distribution labels.

35. The apparatus of claim 33, wherein the distribution labels comprise barcodes.

36. The apparatus of claim 33, wherein the distribution labels include at least one of origin information, destination information, origin date information, and expected delivery date information.

37. The apparatus of claim 22, wherein the permanent identification marker comprises a barcode, a radio frequency identification tag, and a human readable label.

38. The apparatus of claim 22, further comprising:
means for linking the handling units with the transportation container.

39. The apparatus of claim 22, further comprising:
means for creating an electronic manifest corresponding to the transportation unit.

40. The apparatus of claim 39, wherein the electronic manifest comprises an inventory of items loaded into the transportation container.

41. The apparatus of claim 22, further comprising:
means for receiving information pertaining to a license plate associated with a transportation vehicle in which the transportation container is loaded.

42. The apparatus of claim 41, further comprising:
means for linking the transportation vehicle with the transportation container.

43. A computer-readable medium containing instructions for performing a method for tracking assets of a service provider in a transportation network, the method comprising:
assigning a destination and route to a transportation container having an associated permanent identification marker;
generating a unique identification label for the transportation container, wherein the unique identification label includes information regarding the destination and route assigned to the container;
attaching the unique identification label to the transportation container;
receiving first information pertaining to the unique identification label attached to the transportation container; and
receiving second information pertaining to the permanent identification marker associated with the transportation container,
wherein handling units containing delivery items are loaded into the transportation container.

44. The computer-readable medium of claim 43, wherein the delivery items comprise mailpieces.

45. The computer-readable medium of claim 43, wherein the unique identification label is a placard.

46. The computer-readable medium of claim 43, wherein the unique identification label comprises a barcode.

47. The computer-readable medium of claim 43, wherein the unique identification label includes information indicative of a range of delivery areas for contents of the transportation container.

48. The computer-readable medium of claim 43, wherein the unique identification label includes human-readable destination information.

49. The computer-readable medium of claim 43, wherein the permanent identification marker comprises a license plate.

50. The computer-readable medium of claim 43, further comprising:
storing the first information and the second information.

51. The computer-readable medium of claim 43, further comprising:
sending the first information and the second information to a server.

52. The computer-readable medium of claim 43, wherein receiving information pertaining to the unique identification label comprises:
scanning the unique identification label attached to the transportation container to produce first scan data.

53. The computer-readable medium of claim 43, wherein receiving second information comprises:
scanning a license plate associated with the transportation container to produce second scan data.

54. The computer-readable medium of claim 43, further comprising:
receiving information pertaining to distribution labels associated with the handling units, wherein the distribution labels uniquely identify the handling units.

55. The computer-readable medium of claim 54, wherein the distribution labels comprise 24-digit distribution labels.

56. The computer-readable medium of claim 54, wherein the distribution labels comprise barcodes.

57. The computer-readable medium of claim 54, wherein the distribution labels include at least one of origin information, destination information, origin date information, and expected delivery date information.

58. The computer-readable medium of claim 43, wherein the permanent identification marker comprises a barcode, a radio frequency identification tag, and a human readable label.

59. The computer-readable medium of claim 43, further comprising:
linking the handling units with the transportation container.

60. The computer-readable medium of claim 43, further comprising:
creating an electronic manifest corresponding to the transportation unit.

61. The computer-readable medium of claim 60, wherein the electronic manifest comprises an inventory of items loaded into the transportation container.

62. The computer-readable medium of claim 43, further comprising:
receiving information pertaining to a license plate associated with a transportation vehicle in which the transportation container is loaded.

63. The computer-readable medium of claim 62, further comprising:
linking the transportation vehicle with the transportation container.

64. An apparatus for tracking assets of a service provider in a transportation network, comprising:
a memory having a program that: assigns a destination and route to a transportation container having an associated permanent identification marker;
generates a unique identification label for the transportation container, wherein the unique identification label includes information regarding the destination and route assigned to the container, and the unique identification label is attached to the transportation container; receives first information pertaining to the unique identification label attached to the transportation container; and receives second information pertaining to the permanent identification marker associated with the transportation container, wherein handling units containing delivery items are loaded into the transportation container; and
a processor that runs the program.

65. The apparatus of claim 64, wherein the delivery items comprise mailpieces.

66. The apparatus of claim 64, wherein the unique identification label is a placard.

67. The apparatus of claim 64, wherein the unique identification label comprises a barcode.

68. The apparatus of claim 64, wherein the unique identification label includes information indicative of a range of delivery areas for contents of the transportation container.

69. The apparatus of claim 64, wherein the unique identification label includes human-readable destination information.

70. The apparatus of claim 64, wherein the permanent identification marker comprises a license plate.

71. The apparatus of claim 64, wherein the program further stores the first information and the second information.

72. The apparatus of claim 64, wherein the program further sends the first information and the second information to a server.

73. The apparatus of claim 64, wherein receiving information pertaining to the unique identification label comprises:
scanning the unique identification label attached to the transportation container to produce first scan data.

74. The apparatus of claim 64, wherein receiving second information comprises:
scanning a license plate associated with the transportation container to produce second scan data.

75. The apparatus of claim 64, wherein the program further receives information pertaining to distribution labels associated with the handling units, wherein the distribution labels uniquely identify the handling units.

76. The apparatus of claim 75, wherein the distribution labels comprise 24-digit distribution labels.

77. The apparatus of claim 75, wherein the distribution labels comprise barcodes.

78. The apparatus of claim 75, wherein the distribution labels include at least one of origin information, destination information, origin date information, and expected delivery date information.

79. The apparatus of claim 64, wherein the permanent identification marker comprises a barcode, a radio frequency identification tag, and a human readable label.

80. The apparatus of claim 64, wherein the program further links the handling units with the transportation container.

81. The apparatus of claim 64, wherein the program further creates an electronic manifest corresponding to the transportation unit.

82. The apparatus of claim 81, wherein the electronic manifest comprises an inventory of items loaded into the transportation container.

83. The apparatus of claim 64, wherein the program further receives information pertaining to a license plate associated with a transportation vehicle in which the transportation container is loaded.

84. The apparatus of claim 83, wherein the program further links the transportation vehicle with the transportation container.
